(19) United States
(12) Patent Application Publication
(10) Pub. No.: US 2017/0132648 A1
(43) Pub. Date: May 11, 2017

(54) ANONYMOUS REPORTING OF MULTIPLE VENUE LOCATION DATA

(71) Applicant: International Business Machines Corporation, Armonk, NY (US)

(72) Inventors: Lisa Seacat DeLuca, Baltimore, MD (US); Jeremy A. Greenberger, Raleigh, NC (US)

(21) Appl. No.: 14/938,224

(22) Filed: Nov. 11, 2015

(51) Int. Cl. G06Q 30/02

(52) U.S. Cl. CPC G06Q 30/0205

(57) ABSTRACT

Embodiments described herein provide approaches for reporting of location data. Specifically, a device identifier is retrieved from each patron having an enabled mobile device. The device identifier indicates a customer and a location of the customer within one or more venues. A set of baseline venue statistics is calculated for each venue. Also, based on the device identifiers, common patrons are determined among the venues. A set of common patron statistics is calculated for each common patron. The baseline venue and common patron statistics are then reported to a subscribing venue with the identity of the patrons and venues not being revealed.

### BACKGROUND

This invention relates generally to data reporting and, more specifically, to anonymous reporting of multiple venue location data to produce comparison patron analytics and insights across multiple venues.

The amount of information being processed and stored is rapidly increasing as technology advances presents an ever-increasing ability to generate and store data. This data is commonly stored in computer-based systems in structured data stores. For example, one common type of data store is a so-called “flat” file such as a spreadsheet, plain-text document, or XML document. Another common type of data store is a relational database comprising one or more tables. Other examples of data stores that comprise structured data can include, without limitation, files systems, object collections, record collections, arrays, hierarchical trees, linked lists, stacks, and combinations thereof.

Numerous organizations, including industry, retail, and government entities recognize that important information can be obtained and/or decisions can be made if massive data sets can be analyzed to provide insights such as identifying patterns of behavior. Collecting and classifying large sets of data in a timely and efficient manner can allow these entities to more quickly and efficiently provide these insights, thereby allowing them to make more informed decisions.

### SUMMARY

In general, embodiments described herein provide approaches for reporting of location data. Specifically, a device identifier is retrieved from each patron having an enabled mobile device. The device identifier indicates a customer and a location of the customer within one or more venues. A set of baseline venue statistics is calculated for each venue. Also, based on the device identifiers, common patrons are determined among the venues. A set of common patron statistics is calculated for each common patron. The baseline venue and common patron statistics are then anonymously reported to a subscribing venue.

One aspect of the present invention includes a computer-implemented method for anonymous reporting of location data, the method comprising: retrieving a device identifier from each of a plurality of enabled computing devices, the device identifier indicating a patron and a location of the patron within one or more venues; calculating a set of baseline venue statistics for each of the one or more venues; determining, based on the device identifier, at least one common patron in a first venue and a second venue of the one or more venues; calculating a set of common patron statistics for the at least one common patron in the first venue and the second venue; and reporting at least one of: the set of baseline venue statistics for each of the one or more venues, wherein an identity of the one or more venues is not reported; and the set of common patron statistics for the at least one common patron, wherein an identity of the at least one common patron is not reported.

Another aspect of the present invention includes a computer system for anonymous reporting of location data, the computer system comprising: a memory medium comprising program instructions; a bus coupled to the memory medium; and a processor for executing the program instructions, the instructions causing the system to: retrieve a device identifier from each of a plurality of enabled computing devices, the device identifier indicating a patron and a location of the patron within one or more venues; calculate a set of baseline venue statistics for each of the one or more venues; determine, based on the device identifier, at least one common patron in a first venue and a second venue of the one or more venues; calculate a set of common patron statistics for the at least one common patron in the first venue and the second venue; and report at least one of: the set of baseline venue statistics for each of the one or more venues, wherein an identity of the one or more venues is not reported; and the set of common patron statistics for the at least one common patron, wherein an identity of the at least one common patron is not reported.

Yet another aspect of the present invention includes a computer program product for anonymous reporting of location data, the computer program product comprising a computer readable storage device, and program instructions stored on the computer readable storage device, to: retrieve a device identifier from each of a plurality of enabled computing devices, the device identifier indicating a patron and a location of the patron within one or more venues; calculate a set of baseline venue statistics for each of the one or more venues; determine, based on the device identifier, at least one common patron in a first venue and a second venue of the one or more venues; calculate a set of common patron statistics for the at least one common patron in the first venue and the second venue; and report at least one of: the set of baseline venue statistics for each of the one or more venues, wherein an identity of the one or more venues is not reported; and the set of common patron statistics for the at least one common patron, wherein an identity of the at least one common patron is not reported.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a block diagram that illustrates a computer implementation 10 in which the invention may be implemented according to illustrative embodiments;

FIG. 2 shows a block diagram that illustrates a data aggregation tool 200 according to illustrative embodiments;

FIG. 3 shows an example venue configuration 300 of two subscribing venues according to illustrative embodiments;

FIG. 4 shows baseline venue statistics 400 for each subscribing venue at a store level according to illustrative embodiments;

FIG. 5 shows baseline venue statistics 500 for a subscribing venue including zone statistics according to illustrative embodiments;

FIG. 6 shows common patron statistics 600 for a subscribing venue according to illustrative embodiments; and

FIG. 7 shows a process flowchart 700 for anonymous reporting of location data according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission, or viewing devices. The embodiments are not limited in this context.

Also, the term “venue” is defined as any place that can be visited by one or more patrons. The term “patron” as used herein refers to any person having an enabled mobile device allowing the person to be tracked and/or monitored via location sensing technologies as the patron moves in a venue. A patron may include, but is not limited to, a customer, client, frequenter, consumer, user, visitor, guest, or the like.

As stated above, embodiments described herein provide approaches for reporting of location data. Specifically, a device identifier is retrieved from each patron having an enabled mobile device. The device identifier indicates a customer and a location of the customer within one or more venues. A set of baseline venue statistics is calculated for each venue. Also, based on the device identifiers, common patrons are determined among the venues. A set of common patron statistics is calculated for each common patron. The baseline venue and common patron statistics are then anonymously reported to a subscribing venue.

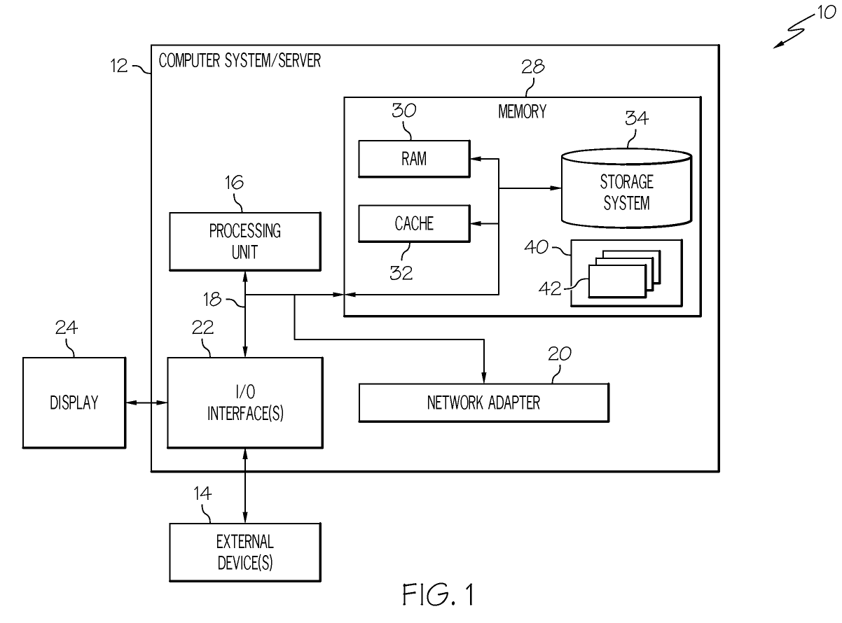

Referring now to FIG. 1, a computerized implementation 10 of an embodiment for anonymous reporting of multiple venue location data to produce patron analytics and insights. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and/or distributed cloud computing environments that include any of the above systems or devices, and the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, and/or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system/server 12 is intended to demonstrate that some or all of the components of implementation 10 could be deployed, managed, serviced, etc., by a service provider who offers to implement, deploy, and/or perform the functions of the present invention for others.

Computer system/server 12 is intended to represent any type of computer system that may be implemented in deploying/realizing the teachings recited herein. Computer system/server 12 may be described in the general context of computer system executable instructions, such as program modules, being executed by a computer system. Generally, program modules may include routines, programs, objects, components, logic, data structures, and/or the like, that perform particular tasks or implement particular abstract data types. In this particular example, computer system/server 12 represents an illustrative system for anonymous reporting of multiple venue location data to produce patron analytics and insights. It should be understood that any other computers implemented under the present invention may have different components/software, but can perform similar functions.

Computer system/server 12 in computerized implementation 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and/or a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as for creating a relationship with a community to enable a user to present browser content based on the browsing behavior of people in the community, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

Movements of a patron (e.g., a customer) having an enabled mobile device can be tracked as the patron moves inside a venue (e.g., mall, stadium, airport, hospital, etc.) using techniques known in the art, such as IBM® Presence Insights. IBM® Presence Insights works by sensing the presence of the mobile device through a collection of location sensing technologies. For example, wireless fidelity (Wi-Fi) enabled mobile devices that connect to a guest Wi-Fi system in a venue, or a venue's mobile app sensing a known Bluetooth beacon. Location sensing via wireless triangulation or satellite may be used as well. After the mobile device is detected, a device identifier (e.g., a Globally Unique Identifier or “GUID”) is assigned for the device. In one example, the device identifier is the MAC address for the device. In another example, a patron may download a software development kit (SDK) to his mobile device. A GUID is then assigned to the mobile device and used as the device identifier. The mobile device is tracked as it moves through the venue. Although, a device identifier is used to track a patron, the patron may remain anonymous because the actual identity including the device identifier may not be shared during data aggregation.

Location sensing technologies enable a venue to extend customer service and support through mobile devices. For example, a retail store can use location sensing to transform the in-store customer experience by using intelligent location-based technology to engage shoppers in near real time to influence and increase sales in the store. The aggregation of this data may also assist the venue to understand trends and performance of their locations by providing insight into the behaviors of its patrons.

Existing location sensing technologies may further collect location data related to position information of mobile devices over time as patrons move through a venue. This location data can then be used for traffic analysis. For example, a retail store may contain multiple departments (e.g., jewelry, sporting goods, women's clothing, etc.). Each department may be defined as a “zone”, with each zone being equipped with one or more location sensors (or beacons) to monitor and track patrons' movements within each respective zone. Each patron may then be tracked as the patron moves from one department to another, with the time spent in each visited department also being collected.

In accordance with the system described in this disclosure, various venues may subscribe to the data aggregation and reporting service. While the location data described above is important and valuable to a venue, embodiments of the present invention provide an added benefit by allowing a subscribing venue to see how it is performing compared to other subscribing venues by aggregating the location data of each of the subscribing venues.

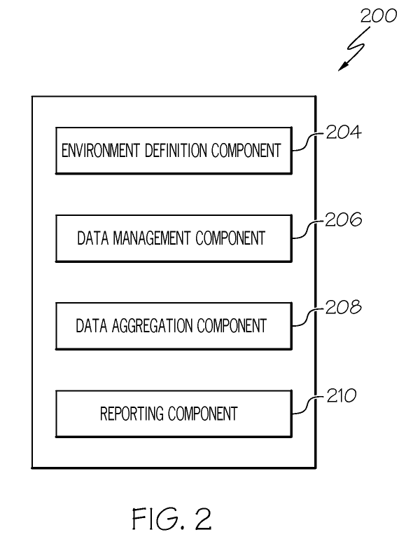

Referring now to FIG. 2, data aggregation tool 200 (embodied in computer system/server 12), which receives and aggregates location data from one or more subscribing venues for reporting purposes, will be described. As shown, data aggregation tool 200 includes environment definition component 204, data management component 206, data aggregation component 208, and reporting component 210.

In some embodiments, environment definition component 204 may receive venue configuration data related to one or more subscribing venues. Venue configuration data may include, among other things, venue name, venue industry (retail, healthcare, etc.), venue geographic location information, venue contact information, etc. Furthermore, venue configuration data may include any number of zones (e.g., monitored departments of a retail store) defined within the venue location, as well as location information related to each zone. In one embodiment, venue configuration data for each monitored venue may be entered via a computing device having at least one input device. In another embodiment, portions of the venue configuration data may be derived based on other received venue configuration data. For example, a venue industry of “Retail” may be derived based on a venue having defined zones of hardware, sporting goods, jewelry, clothing, and automotive.

In some embodiments, one or more subscribing venues employ location sensing technologies (e.g., IBM® Presence Insights) to capture location data of the patrons moving inside its location. As discussed earlier, location sensing technologies track movements of each patron (e.g., a customer) having an enabled mobile device as the patron moves inside a venue by sensing the presence of the mobile device. This venue tracking data includes the collected movements of each tracked patron of the venue.

In some embodiments, data management component 206 may receive venue configuration data. Venue configuration data may be periodically received by data management component 206 (e.g., when a venue configuration data is added or modified), or may be pushed to data management component 206 (e.g., nightly), or may be pulled to data management component 206 (e.g., periodically, dynamically, randomly), or so forth. Furthermore, data management component 206 may also receive venue tracking data. Venue tracking data may be periodically received by data management component 206 (e.g., once per hour), or may be pushed to data management component 206 (e.g., nightly), or may be pulled to data management component 206 (e.g., periodically, dynamically, randomly), or so forth. Venue configuration data and venue tracking data may be received via data transmission. Data transmission may be performed, either wired or wirelessly, in accordance with appropriate transmission principles known in the art, and data encryption may be employed if desired. In addition, venue configuration data, venue tacking data, and/or other information may be stored in one or more databases.

Data aggregation component 208 may aggregate received venue location data to provide analytics (e.g., statistics and trends) allowing a subscribing venue of an industry to have a “baseline” of analytics compared to its subscribing venue competitors in the same industry. In one embodiment, data aggregation component 208 may aggregate location data anonymously for all subscribing venues in a common industry. Although venue names may be collected by environment definition component 204, aggregation and reporting of venue data (i.e., configuration and/or location data) may be done anonymously. In other words, a venue using the described system will be exposed to anonymous location data only. A venue will be unable to tie any received location data back to other venues. For example, Acme Department Store would not want A-Mart Department Store to know that location data being viewed by A-Mart originated from Acme, and vice versa.

In one example, data aggregation component 208 may aggregate received location data by a geographic area, such as a city, state, or region. For example, location data for all subscribing venues in New York City may be aggregated so that a subscribing retail store can see how it compares against other subscribing retail stores in the city.

In another example, data aggregation component 208 may aggregate received location data by a common feature, such as comparable venue space. For example, location data for all subscribing retail stores having at least 5,000 square feet of retail space may be aggregated to provide a subscribing retail store how it compares against other comparably-sized subscribing retail stores. In one embodiment, information related to a common feature may be manually entered. For example, the square footage of a subscribing venue may be manually entered and received by environment definition component 204. In another embodiment, information related to a common feature may be automatically derived using venue configuration data. For example, when defining one or more zones within the venue, a scale may be used to approximate beacon location for store events. This information may be used to approximate the square footage of the store.

In another example, data aggregation component 208 may aggregate received location data by a zone (e.g., electronics, automotive, women's shoes, etc.). For example, aggregated location data from defined electronics departments of all subscribing venues may be aggregated to provide analytics to a subscribing retail store so that the store can see its electronics department relative to other electronics departments. To accomplish this, a zone tag may be assigned to each defined zone (e.g., department or area) within a venue. A zone tag from a subscribing venue may be compared against zone tags of other subscribing venues. Location data from any matching tags may be included in the aggregation. In addition, location data from any similar tags may also be included in the aggregation. For example, a text matching algorithm may be used to determine tags of “TV” and “Television” are similar and may be aggregated together.

In another embodiment, data aggregation component 208 may aggregate location data of patrons who have visited a subscribing venue who are not anonymous to the service. In other words, location sensing technologies may also allow for personal information related to a patron to be collected by one or more subscribing venues. Typically, this is by agreement of the patron. Personal patron information may include, but is not limited to, age, gender, income level, distance from home, etc. Other patron information collected may include spending habits (e.g., amount spent at each venue), shopping habits (e.g., only shops on the weekends), shopping buddies (e.g., who the patron shops with, using known technologies), time in a store (dwell time), which zones are entered (e.g., only visits the electronics section in your store but visits appliances and women's shoes in competitor stores, customer journey (e.g., pattern of movement throughout a store includes women's shoes department to women's clothing department to appliances department to electronics dept.).

In some embodiments, reporting component 210 may provide anonymous data reporting to a subscribing venue based on the data aggregation. Anonymous data reporting may include any number of graphical reports (e.g., charts, graphs, spreadsheets, etc.) which may be generated and displayed on a computing device such as a personal computer (PC), mobile device, or tablet. In one example, reporting component 210 may include pre-configured reports based on aggregated location data. The reports help enable sophisticated analytics of aggregated location data, such as browsing patterns, shopper traffic, and preferences relative to other venues (e.g., business competitors). Alternatively or in addition, a subscribing vendor may be able to create custom reports to gain deep insight into patron data over time relative to other venues. For example, a custom report showing that retailers with their shoe department directly next to their women's active-wear department have a 50% higher dwell time may be created by a subscribing venue not having these adjacent departments. This type of insight may prompt a venue to make store layout changes to boost business or create a better customer experience.

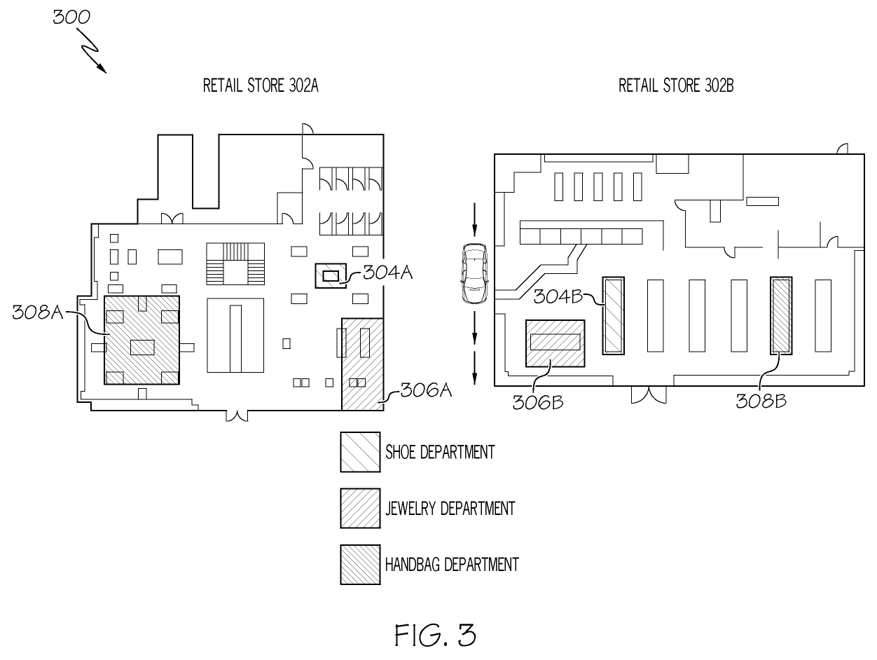

Data aggregation tool 200 and its components may be better understood with reference to an example scenario. FIG. 3 shows example venue configuration 300 of two subscribing venues according to illustrative embodiments. Retail Store 302A and Retail Store 302B are among many retail stores using location sensing technologies (e.g., IBM® Presence Insights) to collect location data on their customers. Environment definition component 204 may be used to define zones related to different departments in each store. As shown, shoe department zone 304A, jewelry department zone 306A, and handbag department zone 308A is defined for Retail Store 302A. Shoe department zone 304B, jewelry department zone 306B, and handbag department zone 308B is defined for Retail Store 302B. Data management component 206 may receive venue configuration data (e.g., zone information) for each subscribing venue.

Location sensing technologies may be used in each department to track customer movements. For example, Bob, Mary, and Jane are regular shoppers to both Retail Store 302A and Retail Store 302B. Location data is collected for customer activity as well as specific activity for Bob, Mary, and Jane. Data management component 206 may receive all venue tracking data for each retail store. Using the venue tracking data received from each store, data aggregation component 208 aggregates all organizations within the retail industry together (Retail Store 302A and Retail Store 302B in this example). In addition, common patron data (e.g., Bob, Mary, and Jane) is aggregated to provide common patron analytics and insights.

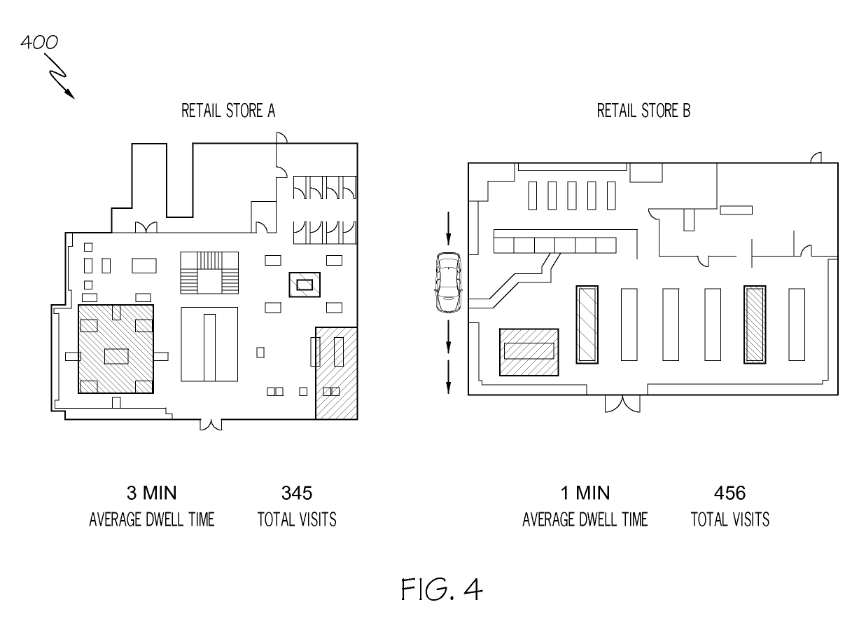

Reporting component 210 may present “baseline” statistics across an industry at a predefined level (e.g., store, region, or zone). FIG. 4 shows baseline statistics 400 for each subscribing venue at a store level. As shown, baseline statistics for each store are presented using the aggregated venue tracking data to show that there were 345 visits to Retail Store 302A with an average dwell time of 3 minutes. By comparison, there were 456 visits to Retail Store 302B with an average dwell time of 1 minute. In this example, retail store 302A has a higher average dwell time than retail store 302B, but may want to determine ways to increase the number of customer visits to its store. Conversely, retail store 302B has a higher number of visits than retail store 302A, but may want to determine ways for it to increase its average dwell time per visit.

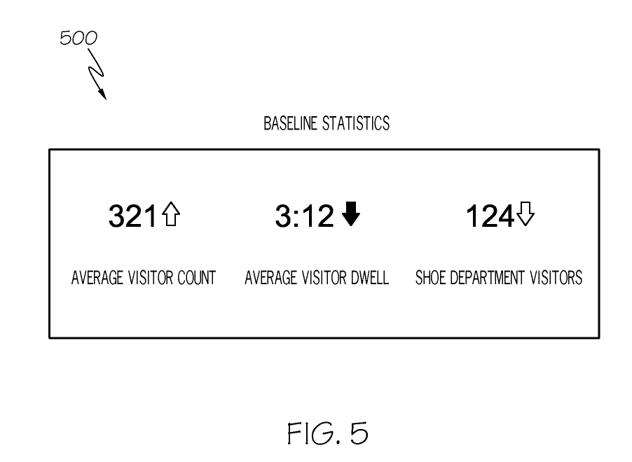

FIG. 5 shows baseline statistics 500 for a subscribing venue including zone statistics. Using aggregated venue tracking data, reporting component 210 may present baseline statistics across an industry at a venue and zone level. As shown, the average visitor count to the subscribing venue was 321, the average visitor dwell time in the store was 3 minutes 12 seconds, and the number of shoe department visitors was 124. The arrows indicate how this compares to the other subscribing venues in the industry. For example, the number of shoe department visitors is less than the average number of shoe department visitors of the remaining industry venues.

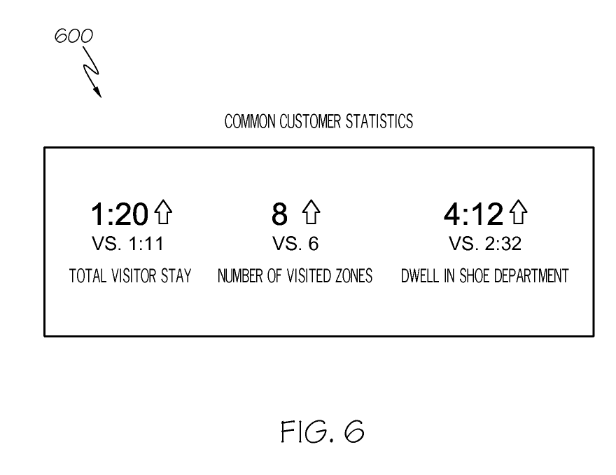

FIG. 6 shows common patron statistics 600 for a subscribing venue. Using aggregated venue tracking data, reporting component 210 may present common patron statistics allowing a subscribing venue insight into the behavior of its customers related to other subscribing venues. As discussed earlier, a device identifier is retrieved from each patron having an enabled mobile device. The device identifier acts as a patron identifier between venues. This allows location data to be collected as a patron moves from one store to another (i.e., a “common patron” or a patron common to multiple venues).

As shown in FIG. 6, common patrons (or patrons visiting more than one subscribing venue, such as Bob, Mary, and Jane in this example) spend an average of 1 minute 20 seconds in a subscribing venue (e.g., retail store 302A), but only an average of 1 minute 11 seconds in other stores. Also, the common patrons visit an average of 8 zones in retail store 302A compared to only 6 zones in the other stores. The common patrons also spend an average of 4 minutes 12 seconds in the shoe department, which is higher than the 2 minutes 32 seconds average spent in the shoe departments of the competitor stores.

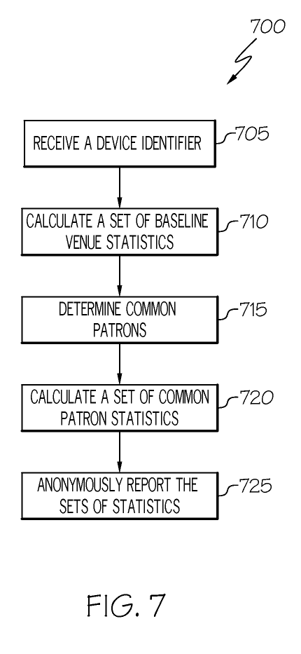

Referring now to FIG. 7, an implementation of a process flowchart 700 for anonymous reporting of location data is shown. At 705, data management component 206 receives a device identifier from any number of enabled computing devices. The device identifier is related to a patron and a location of the patron within one or more venues. At 710, data aggregation component 208 calculates a set of baseline venue statistics for each venue. At 715, data aggregation component 208 determines common patrons visiting the venues. At 720, data aggregation component 208 also calculates a set of common patron statistics for common patrons. At 725, reporting component 210 anonymously reports the set of baseline venue and common patron statistics to a subscribing venue.

Process flowchart 700 of FIG. 7 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for anonymous reporting of multiple venue location data to produce patron analytics and insights. Thus, embodiments herein disclose a process for supporting computer infrastructure, comprising integrating, hosting, maintaining, and deploying computer-readable code into a computing system (e.g., computer system 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for anonymous reporting of multiple venue location data to produce patron analytics and insights. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network (i.e., the Internet, a local area network, a wide area network and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

It is apparent that there has been provided herein approaches for anonymous reporting of multiple venue location data to produce patron analytics and insights. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A computer-implemented method for anonymous reporting of location data, the method comprising:
retrieving a device identifier from each of a plurality of enabled computing devices, the device identifier indicating a patron and a location of the patron within one or more venues;
calculating a set of baseline venue statistics for each of the one or more venues;
determining, based on the device identifier, at least one common patron in a first venue and a second venue of the one or more venues;
calculating a set of common patron statistics for the at least one common patron in the first venue and the second venue; and
reporting at least one of:
the set of baseline venue statistics for each of the one or more venues, wherein an identity of the one or more venues is not reported; and
the set of common patron statistics for the at least one common patron, wherein an identity of the at least one common patron is not reported.

2. The method of claim 1, wherein the set of baseline venue statistics includes at least one of an average dwell time of each patron in each of the one or more venues or an average number of patrons in each of the one or more venues.

3. The method of claim 1, wherein the set of common patron statistics includes an average dwell time of the at least one common patron in the first venue and the second venue.

4. The method of claim 1, wherein each of the one or more venues includes a plurality of zones.

5. The method of claim 4, wherein the set of baseline venue statistics includes at least one of an average dwell time of each patron in each of the plurality of zones or an average number of patrons in each of the plurality of zones.

6. The method of claim 4, wherein the set of common patron statistics includes an average dwell time of the at least one common patron in each of the plurality of zones.

7. The method of claim 1, wherein the one or more venues are associated with an industry.

8. A computer system for anonymous reporting of location data, the computer system comprising:
a memory medium comprising program instructions;
a bus coupled to the memory medium; and
a processor for executing the program instructions, the instructions causing the system to:
retrieve a device identifier from each of a plurality of enabled computing devices, the device identifier indicating a patron and a location of the patron within one or more venues;
calculate a set of baseline venue statistics for each of the one or more venues;
determine, based on the device identifier, at least one common patron in a first venue and a second venue of the one or more venues;
calculate a set of common patron statistics for the at least one common patron in the first venue and the second venue; and
report at least one of:
the set of baseline venue statistics for each of the one or more venues, wherein an identity of the one or more venues is not reported; and
the set of common patron statistics for the at least one common patron, wherein an identity of the at least one common patron is not reported.

9. The computer system of claim 8, wherein the set of baseline venue statistics includes at least one of an average dwell time of each patron in each of the one or more venues or an average number of patrons in each of the one or more venues.

10. The computer system of claim 8, wherein the set of common patron statistics includes an average dwell time of the at least one common customer in the first venue and the second venue.

11. The computer system of claim 8, wherein each of the one or more venues includes a plurality of zones.

12. The computer system of claim 11, wherein the set of baseline venue statistics includes at least one of an average dwell time of each patron in each of the plurality of zones or an average number of patrons in each of the plurality of zones.

13. The computer system of claim 11, wherein the set of common patron statistics includes an average dwell time of the at least one common patron in each of the plurality of zones.

14. The computer system of claim 8, wherein the one or more venues are associated with an industry.

15. A computer program product for anonymous reporting of location data, the computer program product comprising a computer readable storage device, and program instructions stored on the computer readable storage device, to:
retrieve a device identifier from each of a plurality of enabled computing devices, the device identifier indicating a patron and a location of the patron within one or more venues;
calculate a set of baseline venue statistics for each of the one or more venues;
determine, based on the device identifier, at least one common patron in a first venue and a second venue of the one or more venues;
calculate a set of common patron statistics for the at least one common patron in the first venue and the second venue; and
report at least one of:
the set of baseline venue statistics for each of the one or more venues, wherein an identity of the one or more venues is not reported; and
report the set of common patron statistics for the at least one common patron, wherein an identity of the at least one common patron is not reported.

16. The computer program product of claim 15, wherein the set of baseline venue statistics includes at least one of an average dwell time of each patron in each of the one or more venues or an average number of patrons in each of the one or more venues.

17. The computer program product of claim 15, wherein the set of common patron statistics includes an average dwell time of the at least one common customer in the first venue and the second venue.

18. The computer program product of claim 15, wherein each of the one or more venues includes a plurality of zones.

19. The computer program product of claim 18, wherein the set of baseline venue statistics includes at least one of an average dwell time of each patron in each of the plurality of zones or an average number of patrons in each of the plurality of zones, wherein the set of common patron statistics includes an average dwell time of the at least one common patron in each of the plurality of zones.

20. The computer program product of claim 15, wherein the one or more venues are associated with an industry.
